(19) United States
(12) Patent Application Publication
(10) Pub. No.: US 2024/0027623 A1
(43) Pub. Date: Jan. 25, 2024

(54) Method for Determining a Profile Section, 2D Laser Scanner, and System

(71) Applicant: Robert Bosch GmbH, Stuttgart (DE)

(72) Inventors: Chi Fung Chan, Ostfildern (DE); Daniel Marquardt, Neuhausen (DE); Aglaia Bartelmess, Stuttgart (DE); Philip Cheung, Hong Kong (CN); Eddie Kwan, Lam Tin (CN)

(21) Appl. No.: 18/257,191

(22) PCT Filed: Nov. 8, 2021
(86) PCT No.: PCT/EP2021/080942

§ 371 Date: Jun. 13, 2023

(30) Foreign Application Priority Data
Dec. 17, 2020 (DE) 10 2020 216 159.3

(51) Int. Cl. G01S 17/89; G01S 7/4915; G01S 7/497

(52) U.S. Cl. CPC G01S 17/89; G01S 7/4915; G01S 7/497

(57) ABSTRACT

The disclosure relates to a method for determining a profile section of an object and/or space by means of a 2D laser scanner having a laser rangefinder, including:
recording mutually assignable distance measurement values and distance measurement directions by means of the laser rangefinder in a measuring plane traversed radially by a laser beam of the laser rangefinder,
determining the profile section,
from the distance measurement values and distance measurement directions,
determining an angle of inclination of the measuring plane with respect to a reference plane, and
correcting the profile section using the angle of inclination of the measuring plane.

According to the disclosure, the angle of inclination of the measuring plane is determined by using the laser rangefinder.

The disclosure also relates to a 2D laser scanner and to a system.

The invention relates to a method for determining a profile section of an object and/or space by means of a 2D laser scanner having a laser rangefinder. The invention further relates to a 2D laser scanner.

### PRIOR ART

From DE 10 2009 027 668 A1, a laser rangefinder is known in which the laser beam can be rotated within a measuring plane by means of a mirror, in order to measure multiple angle-dependent distances within the measuring plane. These distances are measured between the laser diode emitting a laser beam in the laser rangefinder and the surrounding walls.

### DISCLOSURE OF THE INVENTION

The invention proceeds from a method for determining a profile section of an object and/or space by means of a 2D laser scanner having a laser rangefinder and a 2D laser scanner. The 2D laser scanner comprises at least one laser rangefinder, wherein the 2D laser scanner is configured to record mutually assignable, in particular assigned, distance measurement values and distance measurement directions by means of the laser rangefinder in a measuring plane that is at least partially traversed radially by a laser beam of the laser rangefinder. The 2D laser scanner is used to measure objects and/or spaces while generating a profile section of the object or space, in particular a two-dimensional profile section. Such 2D laser scanners are used by architects, room or building planners, realtors or craftspeople to determine the shape and/or size of spaces and/or objects (such as swimming pools). The 2D laser scanner finds particular application in the context of measuring tasks as they occur in particular in the artisanal field. For example, the 2D laser scanner finds application in an interior design of buildings or in construction work in general.

The 2D laser scanner comprises a laser rangefinder for non-contact distance measurement. The laser rangefinder further comprises at least one laser light source, in particular a laser diode, for generating laser radiation. The laser rangefinder is provided for emitting time-modulated laser radiation in the form of a laser beam in the distance measurement direction towards a target object, the distance of which to the laser rangefinder is to be determined. Laser radiation reflected or scattered by the target object, i.e., radiated back, is at least partially detected by the laser rangefinder, in particular by a receiver of the laser rangefinder, and used to determine the distance measurement value to be measured in the distance measurement direction. The receiver is configured to detect laser radiation that has been radiated back. From the emitted laser radiation and the laser radiation reflected from the surface of the target object, a light transit time is determined by means of a phase comparison and the desired distance measurement value between the laser rangefinder, i.e. the 2D laser scanner, and the target object is determined from the speed of light. Alternatively, the light transit time can also be determined from a flight time determination. The underlying concepts of non-contact distance measurement by laser are known to a person skilled in the art. The terms laser radiation and laser beam are used interchangeably here. By at least partially traverse it is understood that only sections of the plane (for example over an angular range of 180°) are also traversed and/or that the emitted laser beam is temporarily interrupted as it moves in the measuring plane from one distance measurement direction (measuring position) to the next distance measurement direction (measuring position).

The 2D laser scanner is configured to orient the laser beam emitted by means of the laser rangefinder in different spatial directions so that distance measurement values are obtained in different spatial directions, i.e. distance measurement directions. The 2D laser scanner is specifically configured to have the laser beam of the laser rangefinder traverse a measuring plane at least partially in the radial direction—starting from the laser rangefinder in the center. For example, this can be realized by rotating the laser rangefinder about an axis of rotation that is oriented perpendicular to the direction of emission of the laser beam. The zero point of the distance measurement can advantageously lie on the axis of rotation—and thus in the center of the rotational movement. Alternatively, it is conceivable for beam-directing optical elements, for example diffractive elements, mirrors, reflectors or the like, to be used to enable the laser beam to be transmitted in different spatial directions in a technically simple manner, wherein the laser beam of the laser rangefinder also traverses a measuring plane at least partially in the radial direction—starting from the optical element in the center. In particular, the 2D laser scanner can include a drive device for aligning, in particular rotating about the axis of rotation, the laser rangefinder, or the beam-directing optical element. For example, the drive device can be viewed to act via an electric motor or alternatively, using a retractable spring as in an egg timer that is prestressed in such a way and subsequently relaxed again in a defined manner. A particularly simple, automated recording of the distance measurement values in different distance measurement directions is realized by the drive device. The distance measurement direction in three-dimensional space, in particular in the measuring plane traversed by the laser beam, in which the laser beam is transmitted to the target object, is recorded during the execution of a respective distance measurement by means of a sensor or via a control device, for example the drive device. In this sense, the distance measurement direction is also recorded by means of or using the laser rangefinder since a given orientation of the laser rangefinder defines the distance measurement device presently in effect at this time. The recording of the distance measurement direction can be realized, for example, by recording a distance measurement angle, for example an angle of rotation of the laser rangefinder with respect to the aforementioned axis of rotation. The distance measurement direction is so defined by the distance measurement angle with respect to the 2D laser scanner. By aligning the laser beam, in particular as a result of aligning the laser rangefinder, it is possible to perform distance measurements in different distance measuring directions, i.e. different spatial directions, without having to change the position of the 2D laser scanner itself. In this way, the measurement of the object and/or space, and the creation of the profile section is accelerated accordingly compared to the performance of a plurality of individual measurements, because the 2D laser scanner only has to be positioned once (in particular as centrally as possible in the space) and subsequently different distance measurements are carried out without changes in location.

In this way, mutually assignable or assigned distance measurement values and distance measurement directions, in particular distance measurement angles, are determined by means of the laser rangefinder in a measuring plane that is at least partially traversed radially by the laser beam of the laser rangefinder during the execution of a 2D laser scan. By mutually assignable/assigned, it is to be understood that an associated distance measuring direction, in particular an assigned distance measuring angle, is recorded and processed, in particular at least temporarily stored, by means of the 2D laser scanner for each recorded distance measuring value. The recorded distance measurement values and distance measurement directions initially represent a profile section in the abstract form of a 2D point cloud. The profile section should be understood to mean that the data set comprises mutually assigned distance measurement values and distance measurement directions that lie within a measuring plane which is at least partially traversed radially by the laser beam of the laser rangefinder during a 2D laser scan, so that a type of room section—the profile section as an imaginary section of the space produced by the measuring plane—is obtained. The profile section can then be further processed and/or outputted to a user of the 2D laser scanner for example by means of a computing unit, in particular an evaluation unit, and/or using an output device (internal or external to the device) such as a display screen. Further, different evaluations such as surface calculations, angle calculations, creation of floor plans, etc. are conceivable based on the profile section. Various types of evaluation of such profile sections are known to the person skilled in the art.

When measuring typical spaces, most surfaces where laser distance measurement values are measured are vertical walls or horizontal ceilings and floors. In the following, (without limitation to generality) only the case of a measurement of vertical walls—i.e. the measuring plane of the 2D laser scanner is aligned nearly horizontally—is discussed for simplification. It should be noted that the transfer to a measurement with the measuring plane nearly vertically aligned is also easily possible. In the best case scenario, a profile section resulting from the measurement of vertical walls is intended to include distance measurement values and distance measurement directions that lie in an (ideal) horizontal plane. In this case, the horizontal plane is the reference plane. If this is not the case—i.e. the measuring plane has an angle of inclination with respect to the horizontal plane—a distorted profile section results that is not well suited for further evaluation. The method according to the invention allows a profile section initially recorded at an angle of inclination of the measuring plane with respect to the horizontal plane (or generally to a reference plane) in the aftermath of the 2D laser scan by mathematically projecting the recorded distance measurement values and the distance measurement directions onto the (ideal) horizontal plane (or reference plane). Correcting refers to converting the recorded distance measurement values by means of trigonometric functions and using the angle of inclination, wherein distance measurement values projected into the (ideal) horizontal plane (generally: reference plane) are obtained.

In one embodiment of the 2D laser scanner, the scanner comprises a computing unit configured to execute the method according to the invention to determine a profile section. A computing unit, in particular a computer device, is to be understood in particular as a processor unit.

In a further aspect of the invention, a system consisting of a 2D laser scanner and a computing unit realized externally to the 2D laser scanner is proposed. The 2D laser scanner is configured to record, by means of the laser rangefinder, mutually assignable or assigned distance measurement values and distance measurement directions, in particular distance measurement angles, in a measuring plane that is at least partially traversed radially by a laser beam of the laser rangefinder. The computing unit, for example in the form of a smart device, such as a tablet, a smartphone, or the like, is configured to execute the method according to the invention for determining a profile section. In this embodiment, the correction is carried out according to the method according to the invention on a computing unit external to the 2D laser scanner, wherein the profile section required for this purpose and any further information (for example, the angle of inclination or data for determining the same) is provided, in particular transmitted to the external computing unit using a data communication interface of the 2D laser scanner. For example, a data communication interface is understood to be a Bluetooth, Bluetooth Low Energy, WiFi data communication interface or the like. An external computing unit is understood to mean, for example, a smartphone, a cloud, a computer, a tablet, or the like.

The method according to the invention for determining a profile section of an object and/or space proceeds from a method comprising the method steps of:
recording, by means of the laser rangefinder, mutually assignable or assigned distance measurement values and distance measurement directions in a measuring plane that is at least partially traversed radially by a laser beam of the laser rangefinder;
determining the profile section from the distance measurement values and distance measurement directions;
determining an angle of inclination of the measuring plane with respect to a reference plane, particularly a horizontal or a vertical plane;
correcting the profile section using the angle of inclination of the measuring plane.

Correcting the profile section requires knowledge of the angle of inclination of the measuring plane with respect to the reference plane. According to the invention, the angle of inclination of the measuring plane is determined using the laser rangefinder. The reference plane represents a horizontal or vertical plane depending on the direction in which the measuring plane is aligned.

Methods known in the prior art, for example from U.S. Pat. No. 8,699,005 B2, are known for determining the angle of inclination using an accelerometer or an inertia sensor that records the orientation of the laser rangefinder and thus of the measuring plane. This requires the integration of additional particularly precise and consequently expensive sensors in the 2D laser scanner. The proposed method makes it possible to omit additional sensors and still record, in a simple manner, an angle of inclination by means of which the recorded profile section can be corrected.

In one embodiment of the method, the angle of inclination of the measuring plane is determined in an additional, in particular an additional calibration measurement. For example, in one embodiment of the method, during the calibration measurement
a plurality of distance measurement values are also recorded at increasing and/or decreasing (pivot) angles with respect to the measuring plane (i.e., in the same distance measuring direction projected onto the measuring plane—therefore unchanged distance measuring direction) by means of the laser rangefinder in two different, in particular non-collinear and non-parallel distance measuring directions—in each case in addition to a distance measurement value in the measuring plane,
wherein a minimum value of the plurality of the distance measurement values is determined, and wherein a (direction-dependent) angular deviation is determined by means of the minimum value and the distance measurement value in the measuring plane for the respective distance measurement direction,
wherein the angle of inclination of the measuring plane with respect to the reference plane is calculated from the two angular deviations and the angular distance between the two distance measurement directions (difference of the associated distance measurement directions).

In particular, it is conceivable to initiate the execution of a calibration measurement by means of an input means of the 2D laser scanner, whereupon a measurement sequence of the plurality of distance measurements is triggered. During the measurement sequence, the plurality of individual distance measurements transverse to the measuring plane (always starting from the center of the laser rangefinder, only at a (pivot) angle) are then carried out. From this plurality of distance measurements, at least one minimum value is then determined in the distance measurement values, which is precisely the case when the laser beam lies in the reference plane. In this way, it is possible to determine the angular deviations of the measuring plane in this direction simply by pivoting the laser beam during the calibration measurement over the surface to be measured.

In one embodiment of the method, the two different distance measurement directions are selected orthogonally to each other. In this way, a mathematically particularly simple, consequently not very computationally intensive and thus quickly feasible method can be specified.

In one embodiment of the method, the plurality of distance measurement values are recorded at increasing and/or decreasing angles with respect to the measuring plane during manual or automatic tilting (or pivoting) of the laser rangefinder, in particular of the 2D laser scanner. An automatic tilting of the laser rangefinder can be realized, for example, by means of a specific (tilting) actuator. The actuator can be realized in the form of a motor. Alternatively or additionally, a manual tilting can be realized by means of a mechanical pivoting device. In this way, a method can be provided that is capable of being implemented in a constructively simple manner.

In one embodiment of the method, the angle of inclination of the measuring plane is determined from the profile section itself. In particular, it is conceivable that in one embodiment of the method, the angle of inclination is determined by simulation in the event that a distortion of the profile section is compensated as a result of variation (change) of the angle of inclination. In the event that the distortion of the profile section disappears completely (at least within the framework of tolerance limits) and thus is compensated, the simulation-determined (varied) angle corresponds to the angle of inclination of the measuring plane actually sought. Consequently, in this way, a configuration of the method can be specified in which no particular design precautions of the 2D laser scanner need to be provided.

In an alternative or additional embodiment of the method, the angle of inclination is determined by trigonometric calculation from two distance measurement values in different, in particular non-collinear or non-parallel, distance measurement directions as well as from the angular distance between these distance measurement directions. In this way, in particular, the angle of inclination of the measuring plane can be calculated from an adjustment of distance measurement values expected according to a predetermined or pre-determinable angular distance (for example, predetermined by a step width of a stepper motor) with actually recorded distance measurement values. This method is also realizable without special design precautions in the 2D laser scanner.

In one embodiment of the method, the determined angle of inclination of the measuring plane is refined or adjusted using a sensor, in particular an inertial sensor such as a gravitational sensor or an accelerometer or a rotation rate sensor or the like, an inclination sensor, an electro-optical bubble level or an electrolytically-operating sensor. Such sensors, which are known to a person skilled in the art, permit a simple, in particular small-scale integration into the 2D laser scanner.

### DRAWINGS

The invention is explained in further detail in the following description with reference to embodiment examples shown in the drawings. The drawings, the description, and the claims contain numerous features in combination. A person skilled in the art will appropriately also consider the features individually and combine them into further meaningful combinations. In the figures, identical reference numbers denote functionally identical elements.

Shown are:

FIG. 1 a perspective representation of a configuration of the 2D laser scanner,

FIGS. 2a,b a lateral view of the configuration of the 2D laser scanner according to FIG. 1 with a partially opened housing,

FIGS. 3a,b a typical measurement scenario in which the 2D laser scanner according to the invention is used (a) as well as profile sections (b),

FIG. 4 a method diagram of an embodiment example of the method according to the invention,

FIG. 5 a schematic illustration of a method step for determining the angle of inclination.

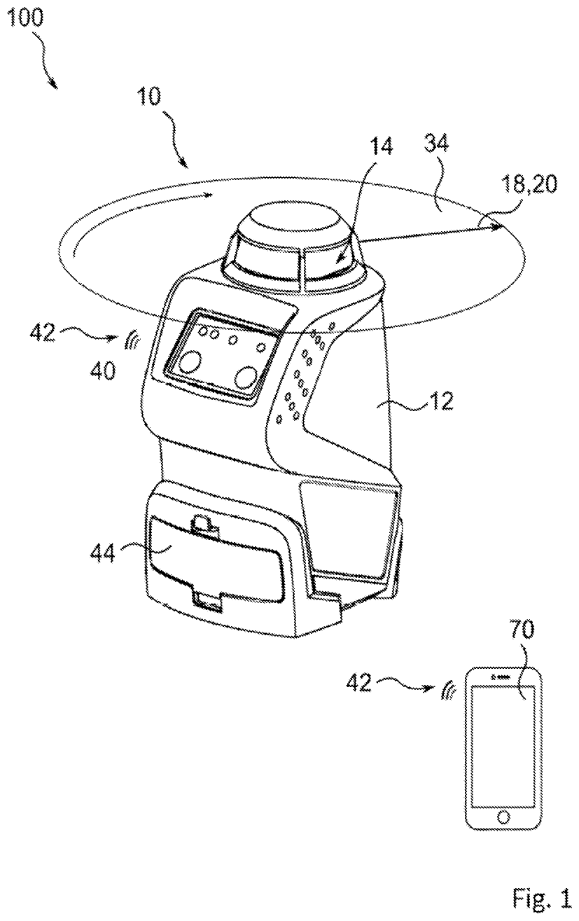

The illustration of FIG. 1 shows a system 100 consisting of a 2D laser scanner 10 and a computing unit 70 realized externally to the 2D laser scanner 10. In particular, one embodiment of the 2D laser scanner 10 according to the invention is shown in a side perspective view.

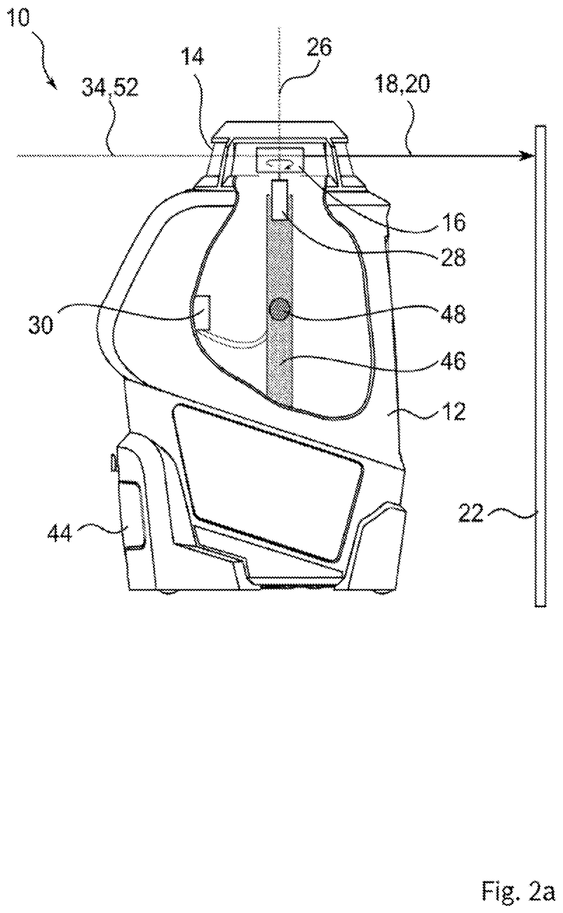

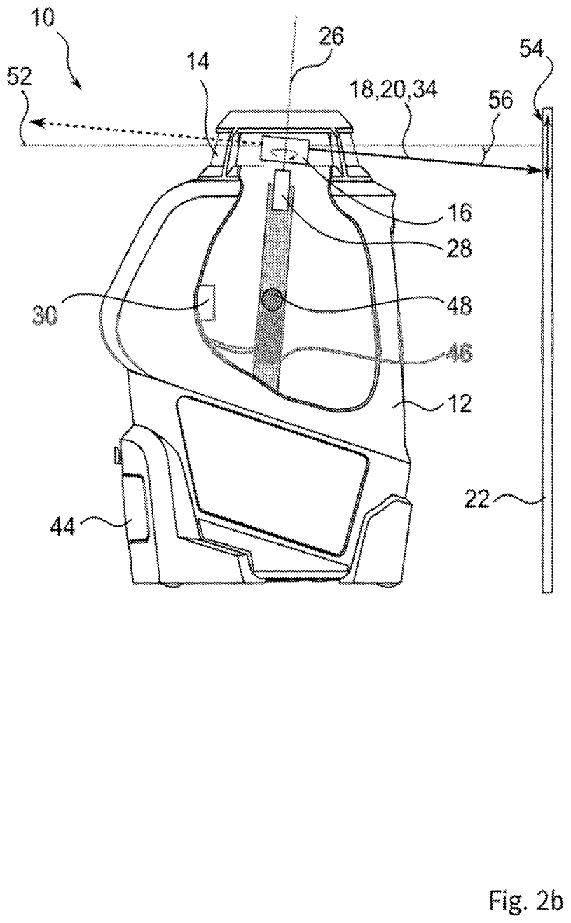

The 2D laser scanner 10 comprises a housing 12 with edge lengths in a range of 4 to 15 cm. The housing 12 encloses the mechanical components as well as the optical and electronic components (see in particular FIGS. 2a,b) of the 2D laser scanner 10 and protects them from mechanical damage and reduces the risk of contamination. An exit opening 14 is provided on the top side of 2D laser scanners 10 and is realized in the form of a dome with transparent windows, the dome projecting from the housing 12.

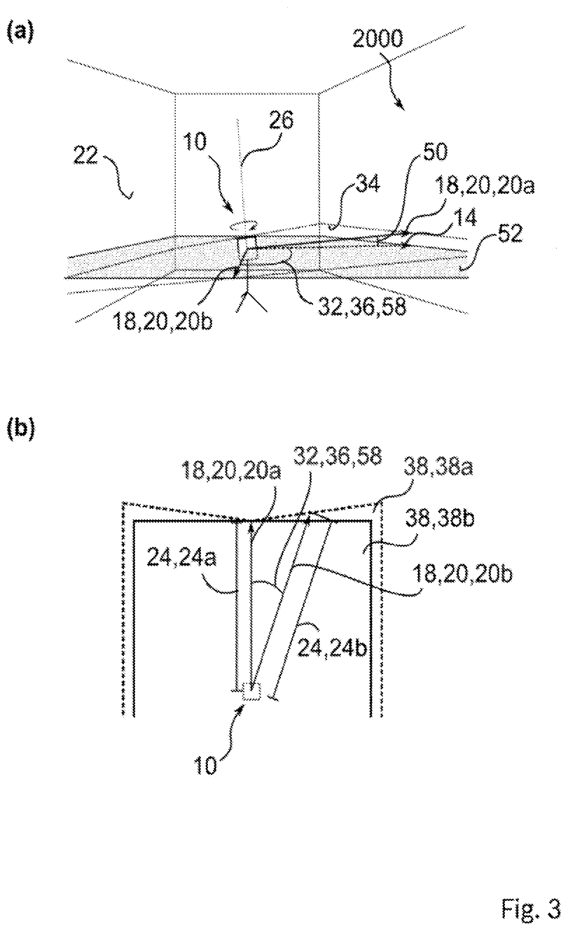

FIGS. 2a and 2b show the same embodiment of the 2D laser scanner 10 shown in FIG. 1 in a side view in which a part of the housing 12 is shown opened. The 2D laser scanner 10 comprises a laser rangefinder 16. The laser rangefinder 16 includes a laser diode, which is not shown in detail, for generating a laser beam 18 which the laser rangefinder 16 may emit. The laser beam 18 can exit the housing 12 through the exit opening 14, in particular the windows. The laser rangefinder 16 serves to perform a non-contact laser distance measurement in a distance measurement direction 20, shown here together with the laser beam 18 by means of arrows. The laser rangefinder 16 further comprises a receiver, not shown in detail here, for detecting laser radiation radiated back from a target object 22 (in FIG. 2a,b, for example, a wall) (not shown in detail here). From the emitted laser beam 18 and the laser radiation reflected by the target object 22, a light transit time is determined by means of a phase comparison and the desired distance measurement value 24 between the laser rangefinder 16, i.e. the 2D laser scanner 10, and the target object 22 is determined from the speed of light (cf. FIG. 3b). The laser rangefinder 16 is rotatably supported about an axis of rotation 26 that is perpendicular to the distance measurement direction 20 of the laser rangefinder 16, wherein an active rotation of the laser rangefinder 16 can be performed by means of a stepper motor 28. The stepper motor 28—in cooperation with a computing unit 30 of the 2D laser scanner 10—is configured to rotate the laser rangefinder 16 by a predetermined or predeterminable angle of rotation 32 (cf. FIG. 3b) between two successive distance measurements (shown by the respective arrows in FIG. 3b). The zero point (or reference point, or starting point) of the distance measurement is on the axis of rotation 26—and thus at the center of the rotational movement and of the 2D laser scanners 10. In this way, the laser beam 18 emitted by the 2D laser scanner 10 can be oriented in different distance measurement directions 20 (cf. 20a, 20b in FIG. 3b). In the process, the laser beam 18 emitted by the 2D laser scanner 10 is emitted in the radial direction (cf. FIG. 1 or FIG. 3b—the distance measurements are performed in the radial direction starting from the 2D laser scanner 10), traversing a measuring plane 34 at least partially (for example, interrupted by temporarily turning off the laser diode).

During the performance of a respective distance measurement, the distance measurement direction 20 of the laser beam 18 is recorded in the form of a distance measurement angle 36 with respect to the axis of rotation 26 in the measuring plane 34 (cf. FIGS. 3a, b)—said angle in this case corresponding to the angle of rotation 32. Thus, the distance measurement direction 20 is defined with respect to the 2D laser scanner 10 by the distance measurement angle 36. A zero point of the distance measurement angle 36 and/or the angle of rotation 32 can in principle be selected as desired, since it only depends on relative angular distances 58 (cf. FIG. 3b).

The 2D laser scanner 10 is configured to automatically measure an object and/or a space (cf. FIG. 3a) by recording distance measurement values 24 and associated distance measurement directions 20 in different directions in the measuring plane 34, and thereby determining a profile section 38 (cf. FIG. 3b).

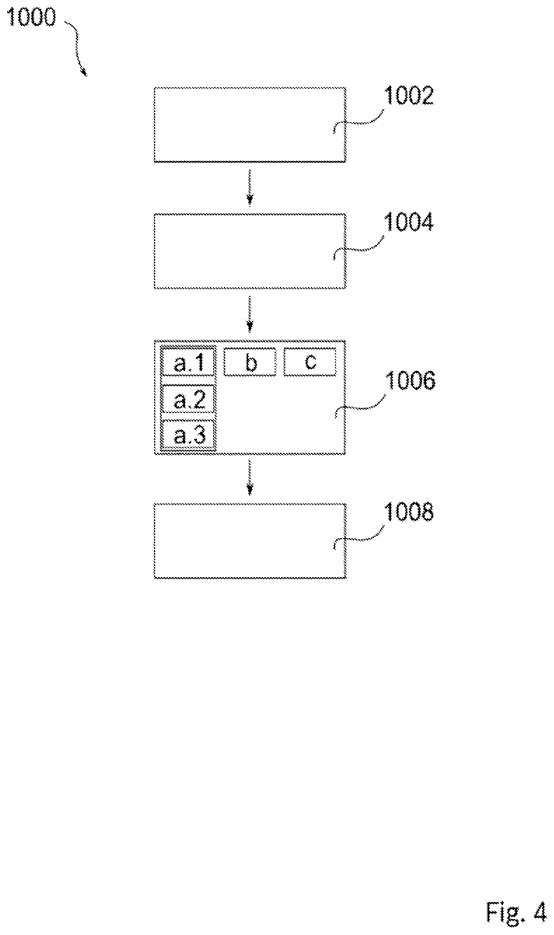

The 2D laser scanner 10 further comprises an operator element 40 for initiating performing a 2D laser scan. Further, the 2D laser scanner 10 comprises a data communication interface, not shown in more detail here, by means of which a recorded profile section 38 as well as further relevant information can be provided to an external computing unit 70, here in the form of a smartphone. For this purpose, the external computing unit 70 also comprises a data communication interface of the same type, which is not shown in more detail here, for example a Bluetooth data communication interface. The transmission of data is shown in FIG. 1 by means of a radio icon 42. The external computing unit 70 comprises a processor device, not shown in more detail here, having a memory unit, wherein a computer program is provided in the memory unit at least for performing a correction of the profile section 38. The external computing unit 70 is configured to carry out the correction as part of the method according to the invention (cf. method step 1008 in FIG. 4). Further, the external computing unit 70 is used here to output the profile section 38 and/or any calculated parameters, for example surface contents, to a user. Alternatively or additionally, it is conceivable that the computing unit 30 of the 2D laser scanner 10 itself is configured to correct a recorded profile section 38 according to the method according to the invention.

Further, the housing 12 of the 2D laser scanner 10 comprises a battery compartment. A battery compartment lid 44 closes the battery compartment flush with the surface of the housing 12. The battery compartment is used to hold batteries (not shown in more detail here) or also rechargeable batteries for powering the 2D laser scanner 10.

In FIGS. 2a, b, in addition to the features shown in FIG. 1, a holder of the laser rangefinder 16 can be seen, at the upper end of which the stepper motor 28 is housed. Further, an actuator 48 can be seen in the form of a pivoting device that serves to tilt the measuring plane 34. By tilting or pivoting the measuring plane 34—cf. FIGS. 2a and 2b viewed together—an angle 56 (which is also in particular a tilt angle 50) can be reached between the measuring plane 34 and a reference plane 52—here selected as a horizontal reference plane 52—(in FIG. 2, this angle 56 is equal to zero, in FIG. 2b, non-zero), wherein an impact point of the laser beam 18 on the target object 22 is altered, represented by arrow 54 in FIG. 2b. The direction indicated by arrow 54 is referred to in this document as transverse with respect to measuring plane 34.

FIG. 3a shows a typical measurement scenario. Here, the 2D laser scanner is positioned in the middle of a space 2000. By successively recording distance values 24 (cf. FIG. 3b) to the walls surrounding the 2D laser scanner 10 as target objects 22 in different distance measurement directions 20, 20a, 20b, a profile section 38 (cf. FIG. 3b) of the space 2000 is determined. In the process, in each case the laser beam 18 is emitted by the 2D laser scanner 10 in the radial direction, wherein in each case the distance measurements lie in the measuring plane 34. If the 2D laser scanner 10 is not leveled during the performance of the 2D laser scan—i.e. if the measuring plane 34 is not parallel to the horizontal reference plane 52 (shown shaded here), but instead has a tilt angle 50 with respect to it—a distorted profile section 38, 38a results, for example as shown in FIG. 3b. The distorted profile section 38, 38a can be corrected using the method 1000 according to the invention (cf. FIG. 4) to form an undistorted profile section 38, 38b, cf. FIG. 3b.

FIG. 4 shows an embodiment example of the method according to the invention for determining and in particular correcting, a profile section 38 of an object—here the space 2000. The profile section 38 is first recorded, in the method steps 1002 and 1004 by means of the 2D laser scanner 10, by recording, in method step 1002, mutually assignable distance measurement values 24 and distance measurement directions 20 by means of the laser rangefinder 16 in the measuring plane 34 at least partially traversed radially by laser beam 18, and, in method step 1004, determining the profile section 38 (for example the profile section 38a as shown in FIG. 3b) from these distance measurement values 24 and assigned distance measurement directions 20 in the form of a filtered and smoothed point cloud. Here, the individual points of the point cloud can also be connected by lines so that the representation of FIG. 3b—profile section 38a—is obtained.

In method step 1006, the angle of inclination 50 of the measuring plane 34 with respect to the reference plane 52, in this case the horizontal reference plane 52, is then determined. This can be done in a variety of ways.

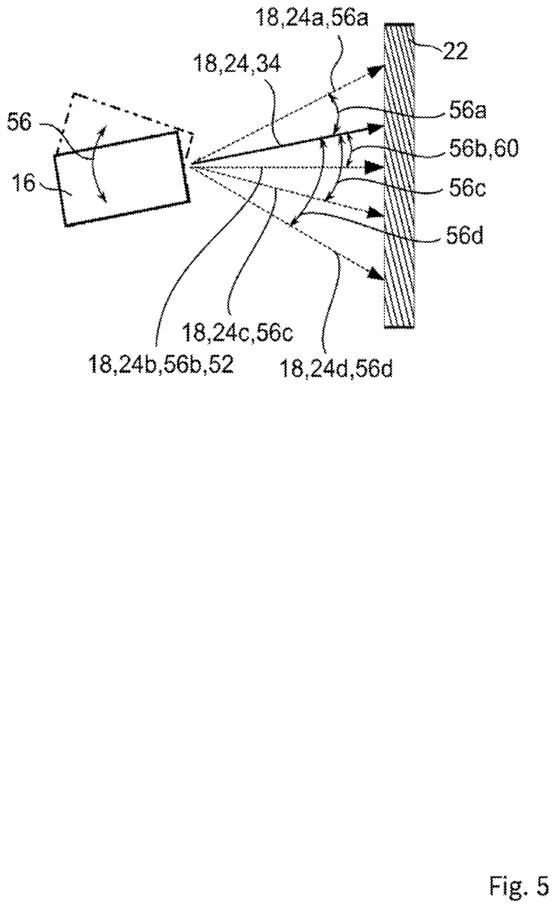

In a first embodiment example of method step 1006—referred to here as (a)—the angle of inclination 50 of the measuring plane 34 is determined in a separate calibration measurement. In the process, in sub-method steps
1006a.1:
a plurality of distance measurement values 24a, 24b, 24c, 24d are also recorded at increasing and/or decreasing angles 56 (cf. FIG. 5 and also FIG. 2b) with respect to the measuring plane 34 by means of the laser rangefinder 16 in two distance measuring directions 20, 20a, 20b that are orthogonal to one another (cf. FIG. 3a)—in each case in addition to the distance measurement value 24 which is in the measuring plane,
1006a.2:
a minimum value (distance measurement value 24b here) of the plurality of distance measurement values 24 is determined and a (direction-dependent) angular deviation is determined by means of the minimum value and the distance measurement value 24 in the measuring plane 34 for the respective distance measurement direction 20, 20a, 20b,
1006a.3:
the angle of inclination 50 of the measuring plane 34 with respect to the reference plane 52 is calculated from the two angular deviations and the angular distance 58 between the two distance measurement directions 20, 20a, 20b.

Method step 1006a.1 is realized using actuator 48 shown in FIG. 2.

In FIG. 5, the measurement principle for a distance measurement direction 20 is shown schematically. Here, in each case in addition to the distance measurement value 24 in the measuring plane 34 (solid arrow), a plurality of distance measurement values 24a, 24b, 24c, 24d (dashed arrows) are recorded in increasing and decreasing angles 56a, 56b, 56c, 56d with respect to the measuring plane 34. From the smallest distance measurement value 24b and the distance measurement value 24 in the measuring plane 34, the angular deviation 60 in this direction (e.g., in distance measurement direction 20a9) is determined by means of trigonometric function.

In a second embodiment example of method step 1006—referred to herein as (b)—the angle of inclination 50 of the measuring plane 34 is determined from the profile section 38, 38a itself, wherein the angle of inclination 50 is determined by simulation in the event that a distortion of the profile section 38, 38a is compensated as a result of variation of the angle of inclination 50 such that the desired profile section 38, 38b (i.e., a straight or kink-free profile expected according to typical wall designs) is obtained.

In a third embodiment example of method step 1006—referred to herein as (c)—the angle of inclination 50 of the measuring plane 34 is determined from the profile section 38, 38a itself by trigonometric calculation of two different, non-collinear or non-parallel distance measurement directions 20, 20a, 20b as well as the angular distance 58 between these distance measurement directions 20, 20a, 20b.

Finally, in method step 1008, the distorted profile section 38, 38a is corrected using the determined angle of inclination 50 of the measuring plane 34 by converting the recorded distance measurement values 20, 20a, 20b by means of trigonometric functions and using the angle of inclination 50, wherein the distance measurement values 20, 20a, 20b are projected into the reference plane 52 in this manner.

1. A method for determining a profile section of an object and/or space using a 2D laser scanner having a laser rangefinder, comprising:
recording mutually assignable distance measurement values and distance measurement directions using the laser rangefinder in a measuring plane traversed radially by a laser beam of the laser rangefinder;
determining the profile section from the distance measurement values and distance measurement directions;
determining an angle of inclination of the measuring plane with respect to a reference plane, in particular a horizontal or a vertical reference plane; and
correcting the profile section using the angle of inclination of the measuring plane, wherein the angle of inclination of the measuring plane is determined using the laser rangefinder.

2. The method of claim 1, wherein the angle of inclination of the measuring plane is determined in a calibration measurement.

3. The method according to claim 2, wherein:
in the calibration measurement a plurality of distance measurement values are also recorded at increasing and/or decreasing angles with respect to the measuring plane using the laser rangefinder in two different, non-parallel distance measuring directions in each case in addition to a distance measurement value in the measuring plane;
a minimum value of the plurality of distance measurement values is determined;
a direction-dependent angular deviation is determined using the minimum value and the distance measurement value of the plurality of distance measurement values in the measuring plane for the respective distance measuring direction; and
an angle of inclination of the measuring plane with respect to the reference plane is calculated from the two direction-dependent angular deviations and the angular distance between the two distance measurement directions.

4. The method according to claim 3, wherein the two different distance measurement directions are orthogonal to each other.

5. The method of claim 3, wherein the plurality of distance measurement values are recorded at increasing and/or decreasing angles with respect to the measuring plane during manual or automatic tilting of the laser rangefinder, in particular of the 2D laser scanner.

6. The method according to claim 1, wherein the angle of inclination of the measuring plane is determined from the profile section.

7. The method according to claim 6, wherein determining the angle of inclination comprises:
compensating a distortion of the profile section resulting from a variation in the angle of inclination; and
determining the angle of inclination by simulation in response to the compensation.

8. The method according to claim 6, wherein the angle of inclination is determined by trigonometric calculation from two distance measurement values in different and non-parallel distance measurement directions as well as the angular distance between these distance measurement directions.

9. The method according to claim 1, wherein the determined angle of inclination of the measuring plane is refined or compensated using a sensor.

10. A 2D laser scanner comprising at least one laser rangefinder, wherein the 2D laser scanner is configured to record mutually assignable distance measurement values and distance measurement directions using the laser rangefinder in a measuring plane that is traversed radially by a laser beam of the laser rangefinder, wherein a computing unit that is configured to execute the method according to claim 1.

11. A system comprising a 2D laser scanner, the 2D laser scanner comprising at least one laser rangefinder, wherein the 2D laser scanner is configured to record mutually assignable distance measurement values and distance measurement directions by means of the laser rangefinder in a measuring plane traversed radially by a laser beam of the laser rangefinder, as well as a computing unit, which is configured to execute the method according to claim 1.

12. The method according to claim 1, wherein the reference plane is one of a horizontal and a vertical reference plane.
